(19) United States
(12) Patent Application Publication
(10) Pub. No.: US 2008/0205318 A1
(43) Pub. Date: Aug. 28, 2008

(54) Apparatus, method and computer program product providing power optimization in battery powered communication devices

(75) Inventors: Chandra Gupta, Bochum (DE); Holger Wirz, Dusseldorf (DE)

Correspondence Address: HARRINGTON & SMITH, PC, 4 RESEARCH DRIVE, SHELTON, CT, 06484-6212, US

(73) Assignee: Nokia Corporation

(21) Appl. No.: 12/072,835

(22) Filed: Feb. 28, 2008

Related U.S. Application Data
(60) Provisional application No. 60/904,023, filed on Feb. 28, 2007.

(51) Int. Cl. G08C 17/00

(52) U.S. Cl. 370/311

(57) ABSTRACT

A method includes determining, based on a received network device resource allocation for an impending operational period, whether a power saving mode can be entered, and if the power saving mode can be entered, selectively controlling at least one of clock signals and power supply voltages of at least a baseband portion of a receiver. Also disclosed is an apparatus that operates in accordance with the method.

### CROSS-REFERENCE TO RELATED APPLICATIONS

This patent application claims priority under 35 U.S.C. §119(e) from Provisional Patent Application No. 60/904,023 filed Feb. 28, 2007, the disclosure of which is incorporated by reference herein in its entirety.

### TECHNICAL FIELD

The exemplary and non-limiting embodiments of this invention relate generally to wireless communication systems, methods, devices and computer program products and, more specifically, relate to techniques for reducing power consumption.

### BACKGROUND

Various abbreviations that appear in the specification and/or in the drawing figures are defined as follows:

3GPP third generation partnership project
ACK acknowledgement
AT allocation table
AMC adaptive modulation and coding
BB baseband
CRC cyclic redundancy check
DL downlink (Node B to UE)
EUTRAN evolved UTRAN
eNB evolved Node-B
FDD frequency division duplex
HARQ hybrid automatic repeat-request
UE user equipment
UL uplink (UE to Node B)
UTRAN UMTS territory radio access network
L2 layer 2 (medium access control, MAC)
LTE long term evolution
MIMO multiple input/multiple output
NACK negative acknowledgement
Node-B base station
OFDMA orthogonal frequency division multiple access
PDU protocol data unit
TDD time division duplex
TTI transmit time interval

A proposed communication system known as evolved UTRAN or E-UTRAN, also referred to as UTRAN-LTE, has been under discussion within the 3GPP. A working assumption is that the downlink (DL) access technique will be OFDMA, and the UL technique will be SC-FDMA.

In the EUTRAN system, as in other communication systems that use portable, battery powered equipment, power saving is an important consideration as it increases battery life and talk times. Power saving becomes even more important in modern wireless communication systems, such as EUTRAN, due at least in part to the higher data rates that are possible. In general, higher speed operation results in increased power consumption.

### SUMMARY

In an exemplary aspect of the invention, there is a method comprising determining, based on a received network device resource allocation for an impending operational period, whether a power saving mode can be entered, and if the power saving mode can be entered, selectively controlling at least one of clock signals and power supply voltages of at least a baseband portion of a receiver.

In another exemplary aspect of the invention, there is a computer readable medium encoded with a computer program executable by a processor to perform actions comprising determining, based on a received network device resource allocation for an impending operational period, whether a power saving mode can be entered, and if the power saving mode can be entered, selectively controlling at least one of clock signals and power supply voltages of at least a baseband portion of a receiver.

In still another exemplary aspect of the invention, there is an apparatus, comprising a receiver comprising baseband circuitry; and a processor configured to determine, based on a received resource allocation for an impending operational period, whether a power saving mode can be entered, said processor further configured to selectively control at least one of clock signals and power supply voltages of at least the baseband circuitry if the power saving mode can be entered.

In yet another exemplary aspect of the invention, there is an apparatus, comprising means for determining, based on a received resource allocation for an impending operational period, whether a power saving mode can be entered, and means for selectively controlling at least one of clock signals and power supply voltages of at least a baseband portion of a receiver if the power saving mode can be entered.

### BRIEF DESCRIPTION OF THE DRAWINGS

The foregoing and other aspects of embodiments of this invention are made more evident in the following Detailed Description, when read in conjunction with the attached Drawing Figures, wherein:

FIGS. 1 and 2 reproduce Tables 7.1.1.2.3.1-1 and 7.1.1.2.3.2-1, respectively, of 3GPP TR 25.814 and show DL scheduling information required by a UE and an UL scheduling grant for a UE, respectively.

FIG. 3 shows a simplified block diagram of various electronic devices that are suitable for use in practicing the exemplary embodiments of this invention.

FIG. 4 illustrates a portion of the UE 10 of FIG. 3 in greater detail according to an exemplary embodiment of the invention.

FIG. 5 is a logic flow diagram that is illustrative of a method, as well as the operation of a computer program product and an apparatus in accordance with the exemplary embodiments of this invention.

### DETAILED DESCRIPTION

The exemplary embodiments of this invention provide a power optimization technique that is suitable for use in OFDMA and similar systems, such as EUTRAN. The exemplary embodiments of this invention in particular take advantage of a DL transmit frame format having a user equipment (UE) allocation table followed by data. The allocation table, or AT, defines for the UE the resources allocated for the UE, in time and frequency, for a next TTI (e.g., for a next 5 ms TTI).

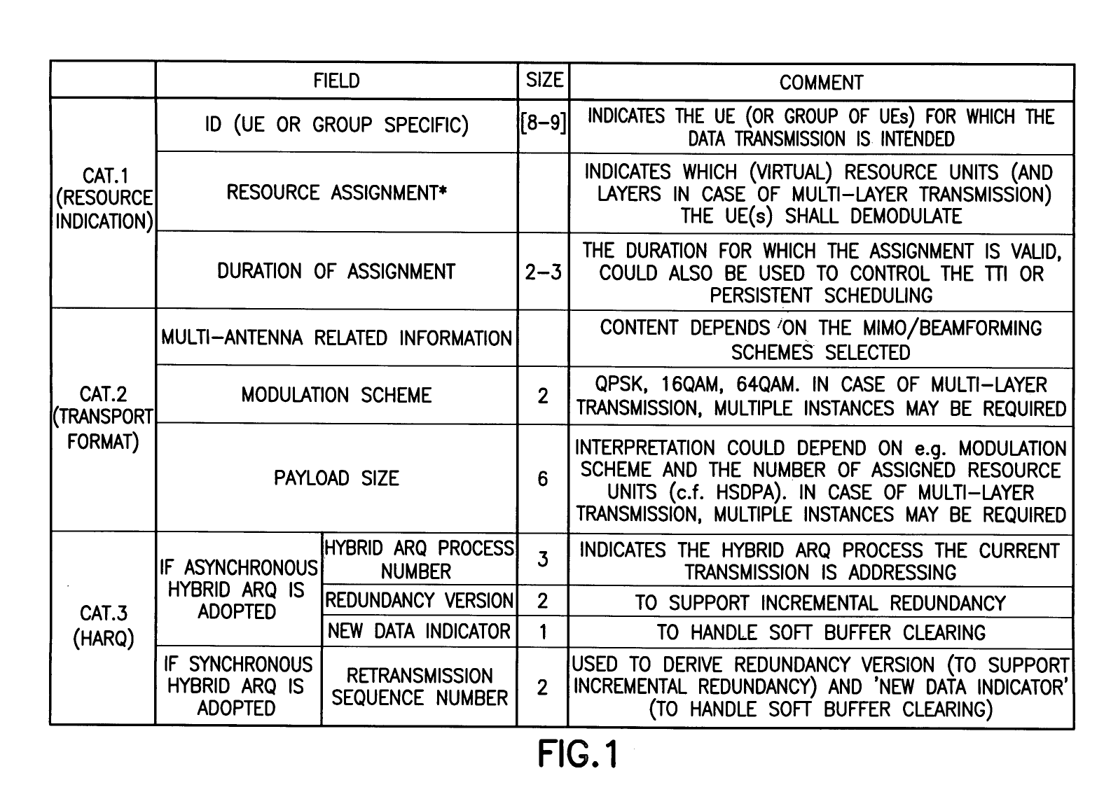

Reference may be made to 3GPP TR 25.814 V7.1.0 (2006-09), 3rd Generation Partnership Project; Technical Specification Group Radio Access Network; Physical layer aspects for evolved Universal Terrestrial Radio Access (UTRA). FIGS. 1 and 2 herein reproduce Tables 7.1.1.2.3.1-1 and 7.1.1.2.3.2-1, respectively, which show the downlink (DL) scheduling information required by a UE and the uplink (UL) scheduling grant for a UE, respectively. Note, for example, the Resource Assignment blocks. For the purposes of describing the exemplary embodiments of this invention at least the DL scheduling information block shown in FIG. 1 may be referred to as the DL allocation table (AT).

Reference may be made to 3GPP TS 36.211 V0.3.1 (2007-02), 3rd Generation Partnership Project; Technical Specification Group Radio Access Network; Physical Channels and Modulation, (Release 8). This 3GPP document describes the physical channels for evolved UTRA.

It is noted that downlink control signaling can include scheduling information for downlink data transmission, and scheduling grant for uplink transmission, and ACK/NAK in response to uplink transmission. The transmission of control signaling from these groups is mutually independent. For example an ACK/NAK can be transmitted to a UE regardless of whether the same UE is receiving scheduling information or not.

In addition, downlink scheduling information is used to inform the UE how to process the downlink data transmission. The information signaled to a UE scheduled to receive user data is summarized in FIG. 1. The category 3 information as illustrated in FIG. 1 is transmitted for every TTI of data to the scheduled user or users. Further, both an asynchronous and synchronous hybrid ARQ operation for the transmission of this information has been submitted to the 3GPP standards body.

Additionally, in relation to FIG. 1 for a case of a multi-layer transmission to a UE, multiple instances of and/or parts of category 2 information and category 3 information may be required. It is noted that 3GPP submissions include that information about multi-layer transmission can be in either ‘resource assignment’ or ‘multi-antenna related information’ as illustrated in category 1 and category 2 of FIG. 1, respectively. Further, it is noted that uplink scheduling grants are used to assign resources to a UE for uplink data transmission.

The information signaled to a UE receiving an uplink scheduling grant is summarized in FIG. 2. The modulation and coding scheme to use for uplink transmission is implicitly shown by the resource assignment field and the transport format (TF) field as illustrated in FIG. 2. It is noted that it has been submitted to the 3GPP standards body that the transport format the UE uses can be either mandated by the Node B or controlled by the UE.

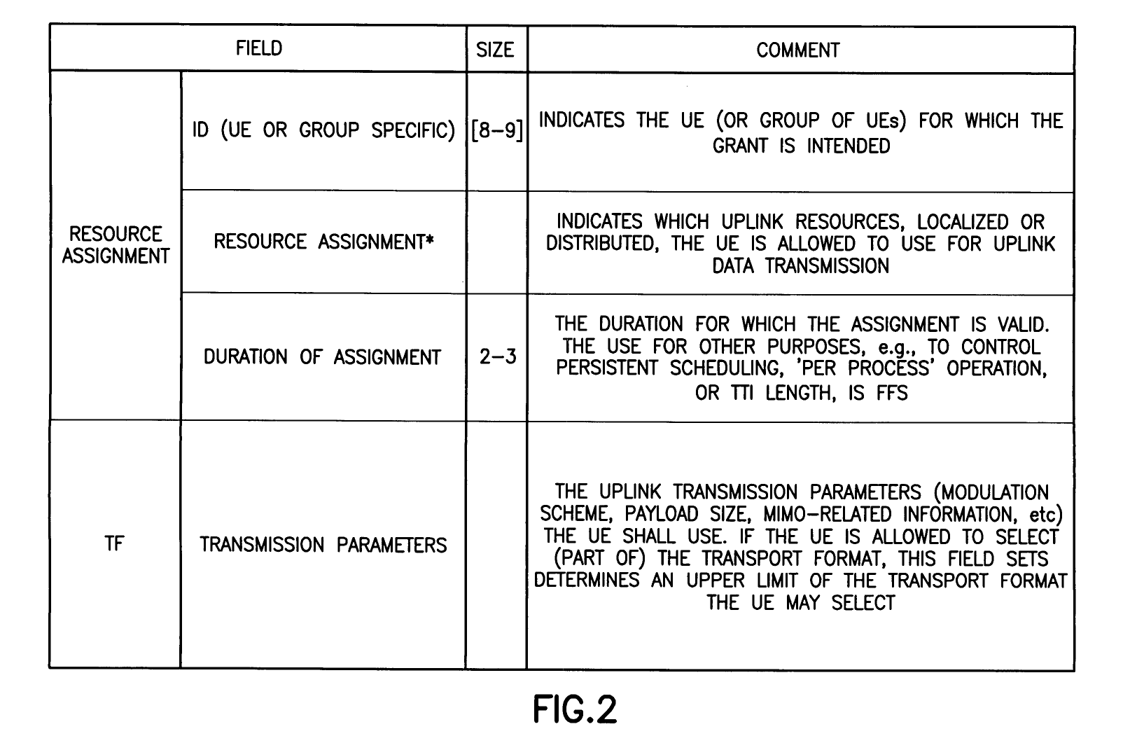

Turning now to FIG. 3, there is shown a simplified block diagram of various electronic devices that are suitable for use in practicing the exemplary embodiments of this invention. In FIG. 3 a wireless network 1 is adapted for communication with a UE 10 via a Node B (base station) 12, which may be referred to herein as an eNB 12. The network 1 may include a network control element (NCE) 14. The UE 10 includes a data processor (DP) 10A, a memory (MEM) 10B that stores a program (PROG) 10C, and a suitable radio frequency (RF) transceiver 10D for bidirectional wireless communications with the Node B 12, which also includes a DP 12A, a MEM 12B that stores a PROG 12C, and a suitable RF transceiver 12D. The Node B 12 is coupled via a data path 13 to the NCE 14 that also includes a DP 14A and a MEM 14B storing an associated PROG 14C. At least the PROG 10C is assumed to include program instructions that, when executed by the associated DP 10A, enable the UE 10 to operate in accordance with the exemplary embodiments of this invention, as will be discussed below in greater detail.

That is the exemplary embodiments of this invention may be implemented at least in part by computer software executable by the DP 10A of the UE 10, or by hardware, or by a combination of software and hardware.

In general, the various embodiments of the UE 10 can include, but are not limited to, cellular phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B, 12B and 14B may be of any type suitable to the local technical environment and may be implemented using any suitable data storage technology, such as semiconductor-based memory devices, magnetic memory devices and systems, optical memory devices and systems, fixed memory and removable memory. The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

The exemplary embodiments of this invention provide power saving techniques for mobile devices, such as those operated in an OFDMA system.

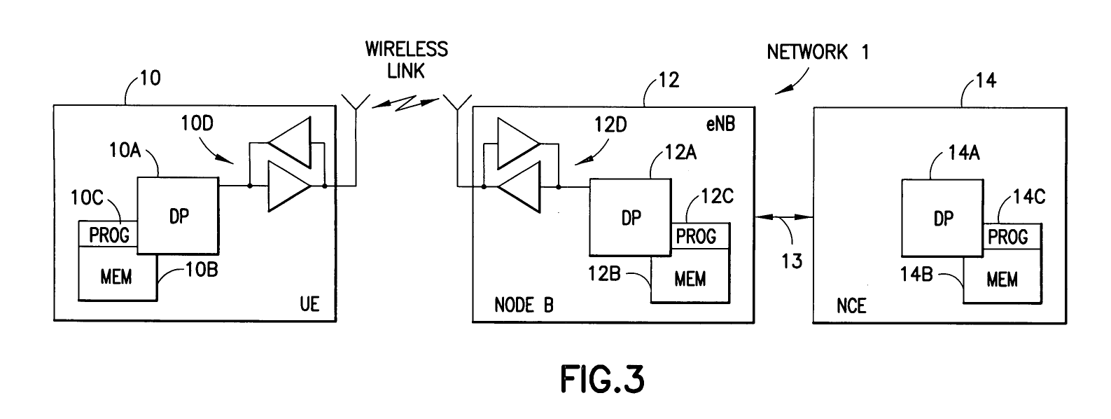

Reference is made to FIG. 4 for showing in greater detail a portion of the UE 10. The UE 10 includes an RF portion 11 and a BB portion 13. The BB portion 13 processes the received DL signal to provide digital data that can be operated on by the DP 10A. A portion of this digital data is descriptive of the AT 15 that is transmitted from the eNB 12, and that defines the UE 10 UL resource allocations (e.g., frequency sub-bands and times) for a next TTI.

The exemplary embodiments of this invention use the information in the AT 15 to reduce, when possible, the UE 10 power consumption on the basis of the resource allocation(s) and in some embodiments, also based on the AMC. Upon receiving and decoding the AT 15, and thus becoming aware of when the UE 10 needs to be operational during the TTI (if at all), those circuit blocks operating in the frequency domain of the receiver BB 13 can be optimized for power consumption via, as non-limiting examples, clock gating, clock frequency scaling and/or by controlling the supply voltage.

FIG. 4 shows a plurality of control outputs 17A, 17B, 17C from the DP 10A to the BB portion 13. The control output 17A is used for performing clock gating (selectively turning certain clock signals on and off), as well as for frequency scaling, such as reducing the frequency of certain clock signals. By turning off certain clock signals and/or reducing the frequency of others the power consumption of the circuitry that uses these clock signals is reduced. The control outputs 17B and 17C provide for selectively scaling (e.g., reducing) the power supply voltage(s) and/or selectively turning off certain power supply voltage(s) to certain BB circuit modules and functional units, respectively. The DP 10A drives the control outputs 17A, 17B and 17C based at least in part on the content of the AT 15 for the next TTI, and possibly also in accordance with the currently used AMC.

More specifically, when the AT 15 information is decoded (at the beginning of a TTI frame) the DP 10A becomes aware, by operation of the program 10C, of which resource blocks in the frequency and time domains are allocated for the UE 10. For a case where there is no data scheduled for the UE 10 (to receive on the DL) a “micro-sleep” cycle may be initiated by one or more of clock gating/clock frequency scaling (control output 17A), and/or scaling down of the supply voltage (control output 17B) and/or powering down of unused circuitry (control output 17C). The micro-sleep cycle may be used at least between received pilots symbols, thereby achieving an approximately 30% saving in the digital BB portion 13.

In general, the micro-sleep cycle may only be used if there is no data to be processed in the TTI. It is also within the scope of the exemplary embodiments of this invention to decode only one or more OFDM symbols per TTI frame (e.g., SysInfo, paging information data, which do not use resource blocks over the complete TTI), and to then enter the micro-sleep cycle during remaining non-pilot symbols. In general, then, the micro-sleep cycle may be used for all or a portion of the TTI.

It should also be noted that while the exemplary embodiments have been described in the context of selectively controlling at least one of clock signals and supply voltages to the BB portion 13, it is within the scope of the exemplary embodiments to also control certain aspects of the RF portion 11 to reduce power consumption, such as by (as non-limiting examples) controlling supply and/or bias voltages to frequency generation components, such as voltage controlled oscillators (VCOs), and controlling supply and/or bias voltages of amplifiers, demodulators and mixers.

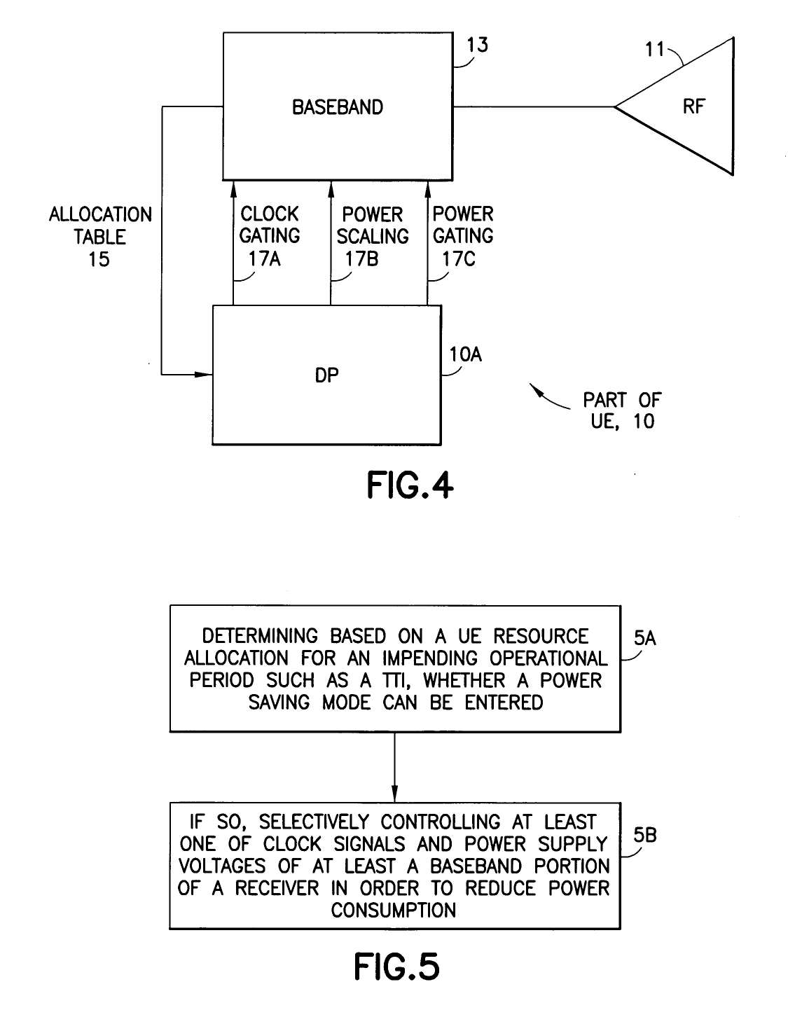

Based on the foregoing it should be apparent that the exemplary embodiments of this invention provide a method, apparatus and computer program product(s), as in the method shown in FIG. 5, to determine (Block 5A), based on a UE resource allocation for an impending operational period, such as a TTI, whether a power saving mode can be entered and, if so, (Block 5B) to selectively control at least one of clock signals and power supply voltages of at least a baseband portion of a receiver in order to reduce power consumption.

The method, apparatus and computer program product(s) of the preceding paragraph, where the receiver operates in an OFDMA wireless communication system.

The method, apparatus and computer program product(s) of the preceding paragraphs, where the UE resource allocation is conveyed by an allocation table that is received from a network node during the TTI.

The method, apparatus and computer program product(s) of the preceding paragraphs, where the determination is also based on a current AMC scheme.

The blocks shown in FIG. 5 may be viewed as method steps, and/or as operations that result from operation of computer program code, and/or as a plurality of coupled logic circuit elements constructed to carry out the associated function(s).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules. The design of integrated circuits is by and large a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the EUTRAN (UTRAN-LTE) system, it should be appreciated that the exemplary embodiments of this invention are not limited for use with only this one particular type of wireless communication system, and that they may be used to advantage in other wireless communication systems.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

What is claimed is:

1. A method, comprising:
determining, based on a received network device resource allocation for an impending operational period, whether a power saving mode can be entered; and
if the power saving mode can be entered, selectively controlling at least one of clock signals and power supply voltages of at least a baseband portion of a receiver.

2. The method of claim 1, where the selectively controlling is performed in order to reduce power consumption of the network device.

3. The method of claim 1, where the selectively controlling is performed in order to selectively turn off at least one power supply voltage to at least one baseband circuit component.

4. The method of claim 1, where the selectively controlling further comprises controlling at least one of supply voltages and bias voltages of at least one of amplifiers, demodulators, and mixers of the receiver.

5. The method of claim 1, where the impending operational period is a transmission time interval.

6. The method of claim 1, where the receiver operates in an orthogonal frequency division multiple access wireless communication system.

7. The method of claim 1, where the network device resource allocation is conveyed by an allocation table that is received from a network node during a transmission time interval.

8. The method of claim 1, where the determination is also based on a current adaptive modulation and coding scheme.

9. The method of claim 1 executed in a mobile user device.

10. A computer readable medium encoded with a computer program executable by a processor to perform actions comprising:
determining, based on a received network device resource allocation for an impending operational period, whether a power saving mode can be entered; and
if the power saving mode can be entered, selectively controlling at least one of clock signals and power supply voltages of at least a baseband portion of a receiver.

11. The computer readable medium encoded with a computer program of claim 10, where the selectively controlling is performed in order to reduce power consumption of the network device.

12. The computer readable medium encoded with a computer program of claim 10, where the selectively controlling is performed in order to selectively turn off at least one power supply voltage to at least one baseband circuit component.

13. The computer readable medium encoded with a computer program of claim 10, where the selectively controlling further comprises controlling at least one of supply voltages and bias voltages of at least one of amplifiers, demodulators, and mixers of the receiver.

14. The computer readable medium encoded with a computer program of claim 10, where the impending operational period is a transmission time interval.

15. The computer readable medium encoded with a computer program of claim 10, where the receiver operates in an orthogonal frequency division multiple access wireless communication system.

16. The computer readable medium encoded with a computer program of claim 10, where the network device resource allocation is conveyed by an allocation table that is received from a network node during a transmission time interval.

17. The computer readable medium encoded with a computer program of claim 10, where the determination is also based on a current adaptive modulation and coding scheme.

18. The computer readable medium encoded with a computer program of claim 10 executed in a mobile user device.

19. An apparatus, comprising:
a receiver comprising baseband circuitry; and
a processor configured to determine, based on a received resource allocation for an impending operational period, whether a power saving mode can be entered, said processor further configured to selectively control at least one of clock signals and power supply voltages of at least the baseband circuitry if the power saving mode can be entered.

20. The apparatus of claim 19, where the processor is further configured to selectively turn off at least one supply voltage to at least one baseband circuit component.

21. The apparatus of claim 19, comprising the processor is further configured to selectively scale at least one of supply voltages and bias voltages of at least one of amplifiers, demodulators, and mixers of the receiver if the power saving mode can be entered.

22. The apparatus of claim 19, where the impending operational period is a transmission time interval.

23. The apparatus of claim 19, where the receiver operates in an orthogonal frequency division multiple access wireless communication system.

24. The apparatus of claim 19, where the resource allocation is conveyed by an allocation table that is received from a network node during a transmission time interval.

25. The apparatus of claim 19, where the processor is further configured to determine, based on a current adaptive modulation and coding scheme, whether a power saving mode can be entered.

26. The apparatus of claim 19 embodied in a mobile user device.

27. An apparatus, comprising:
means for determining, based on a received resource allocation for an impending operational period, whether a power saving mode can be entered; and
means for selectively controlling at least one of clock signals and power supply voltages of at least a baseband portion of a receiver if the power saving mode can be entered.

28. The apparatus of claim 27, where the selectively controlling is performed in order to reduce power consumption of the apparatus.

29. The apparatus of claim 27, where the selectively controlling is performed in order to selectively turn off at least one power supply voltage to at least one baseband component

30. The apparatus of claim 27, further comprising means for selectively controlling at least one of supply voltages and bias voltages of at least one of amplifiers, demodulators, and mixers of the receiver if the power saving mode can be entered.

31. The apparatus of claim 27, where the means for determining and the means for electively controlling comprises a processor coupled to a memory.
